(19) United States
(12) Patent Application Publication
(10) Pub. No.: US 2019/0123592 A1
(43) Pub. Date: Apr. 25, 2019

(54) WIRELESS CHARGING DEVICE AND DISPLAY DEVICE

(71) Applicant: BOE TECHNOLOGY GROUP CO., LTD., Beijing (CN)

(72) Inventor: Chao ZHANG, Beijing (CN)

(21) Appl. No.: 16/023,269

(22) Filed: Jun. 29, 2018

(30) Foreign Application Priority Data
Oct. 23, 2017 (CN) 201710992873.9

(51) Int. Cl. H02J 50/30; H02S 99/00; F21V 8/00; H02J 7/02

(52) U.S. Cl. CPC H02J 50/30; H02S 99/00; G02B 6/0031; H02J 7/025; G02B 6/0078; G02B 6/0028; G02B 6/003

(57) ABSTRACT

A wireless charging device and a display device are provided. The wireless charging device includes a photovoltaic cell panel, a light guide plate and a light source. The light source is configured to provide the light guide plate with incident light. The light guide plate is configured to emit first outgoing light from a first side of the light guide plate to the photovoltaic cell panel, and emit second outgoing light from a second side of the light guide plate opposite to the first side. The photovoltaic cell panel is configured to generate electrical power according to the first outgoing light.

### CROSS-REFERENCE TO RELATED APPLICATIONS

The present application claims the priority of the Chinese Patent Application No. 201710992873.9, filed on Oct. 23, 2017, the contents of which are incorporated herein in their entirety by reference.

### TECHNICAL FIELD

The present disclosure relates to the field of wireless charging technology, and in particular, relates to a wireless charging device and a display device.

### BACKGROUND

With the development of technology and the improvement of the quality of human life, the technology of wireless charging (also referred to as wireless power transmission) is applied to more and more electrical appliances. For example, some types of mobile phones have been implemented with the function of wireless charging. Large-sized display devices such as a television set are important household electric appliances, and also have a great demand for the function of wireless charging. Typical wireless charging technologies include an electric field coupling technology, an electromagnetic induction technology, a resonance (magnetic resonance) technology, a radio wave technology, and a photoelectric charging technology.

### SUMMARY

Embodiments of the present disclosure provide a wireless charging device and a display device.

Some embodiments of the present disclosure provide a wireless charging device, including a photovoltaic cell panel, a light guide plate and a light source, wherein

the light source is configured to provide the light guide plate with incident light;

the light guide plate is configured to emit first outgoing light from a first side of the light guide plate to the photovoltaic cell panel, and emit second outgoing light from a second side of the light guide plate opposite to the first side; and

the photovoltaic cell panel is configured to generate electrical power according to the first outgoing light.

In an embodiment, the light source includes a light source generator and a transflective layer, the transflective layer includes a plurality of transflective films arranged sequentially and with an interval therebetween;

the light source generator is configured to provide a light beam emitted therefrom to the transflective layer; and

the transflective layer is configured to transform the light beam emitted from the light source generator into incident light for the light guide plate, and provide the incident light to the light guide plate.

In an embodiment, the transflective layer further includes one reflector provided at a side of all of the plurality of transflective films distal to the light source generator.

In an embodiment, the light source further includes a coupler provided between the light source generator and the transflective layer, and configured to couple the light beam emitted from the light source generator to the transflective layer.

In an embodiment, the light source further includes a plurality of lenses in one-to-one correspondence with the plurality of transflective films, and the plurality of lenses are provided between the transflective layer and the light guide plate.

In an embodiment, each of the plurality of lenses is provided between a corresponding one of the transflective films and the light guide plate.

In an embodiment, the light source further includes a lens corresponding to the reflector and provided between the reflector and the light guide plate.

In an embodiment, each of the plurality of lenses includes one of a convex lens and a concave lens.

In an embodiment, the lens corresponding to the reflector includes one of a convex lens and a concave lens.

In an embodiment, the transflective layer further includes a support on which the plurality of transflective films and the reflector are provided.

In an embodiment, the transflective layer further includes an optical waveguide in which the plurality of transflective films and the reflector are provided.

In an embodiment, the plurality of transflective films and the reflector are arranged to be inclined relative to an axis of the light beam emitted from the light source generator.

In an embodiment, the plurality of transflective films and the reflector have a same inclination angle relative to the axis of the light beam emitted from the light source generator.

In an embodiment, the inclination angle of the plurality of transflective films and the reflector relative to the axis of the light beam emitted from the light source generator is 45 degrees.

In an embodiment, the light guide plate includes a plurality of light guide strips and a plurality of spacers, and the plurality of light guide strips and the plurality of spacers are arranged alternately.

In an embodiment, the light source includes a light source generator, a main fiber and a plurality of sub-fibers in one-to-one correspondence with the plurality of light guide strips, and each of the plurality of light guide strips is connected to the main fiber through a corresponding sub-fiber.

In an embodiment, the light source generator is configured to emit light and provide the light to the main fiber;

the main fiber is configured to introduce the light emitted from the light source generator into the plurality of sub-fibers to form incident light of the light guide plate; and

each of the plurality of sub-fibers is configured to provide the incident light to a corresponding light guide strip.

In an embodiment, the light source generator is a laser generator, and the light emitted from the light source generator is laser.

Some embodiments of the present disclosure provide a display device, including the wireless charging device provided by the embodiments of the present disclosure and a display panel, wherein

the photovoltaic cell panel is located at the first side of the light guide plate, and the display panel is located at the second side of the light guide plate.

### BRIEF DESCRIPTION OF THE DRAWINGS

FIG. 1 is a schematic diagram showing a structure of a wireless charging device according to an embodiment of the present disclosure;

FIG. 2 is a schematic diagram showing a structure of a light source of the wireless charging device shown in FIG. 1;

FIG. 3 is a schematic perspective diagram showing a light source and a light guide plate of a wireless charging device according to another embodiment of the present disclosure;

FIG. 4 is a schematic plan view showing the light source and the light guide plate shown in FIG. 3;

FIG. 5 is a schematic diagram showing a structure of a display device according to another embodiment of the present disclosure; and

FIG. 6 is a schematic diagram showing a structure of another display device according to another embodiment of the present disclosure.

### DETAILED DESCRIPTION

For better understanding of the technical solutions according to the present disclosure by one of ordinary skill in the art, a wireless charging device and a display device according to the present disclosure will be described in detail below with reference to the accompanying drawings.

The inventor of the present disclosure found that, when operating, some existing display devices (e.g., an electronic picture frame) are still charged in a manner of wired charging, i.e., are still charged by using a power line. The power line connected to the display device forms a “tail” of the display device, and thus degrades the aesthetic property of the display device. Therefore, it is desired to provide a wireless charging device and a display device which have improved aesthetic properties.

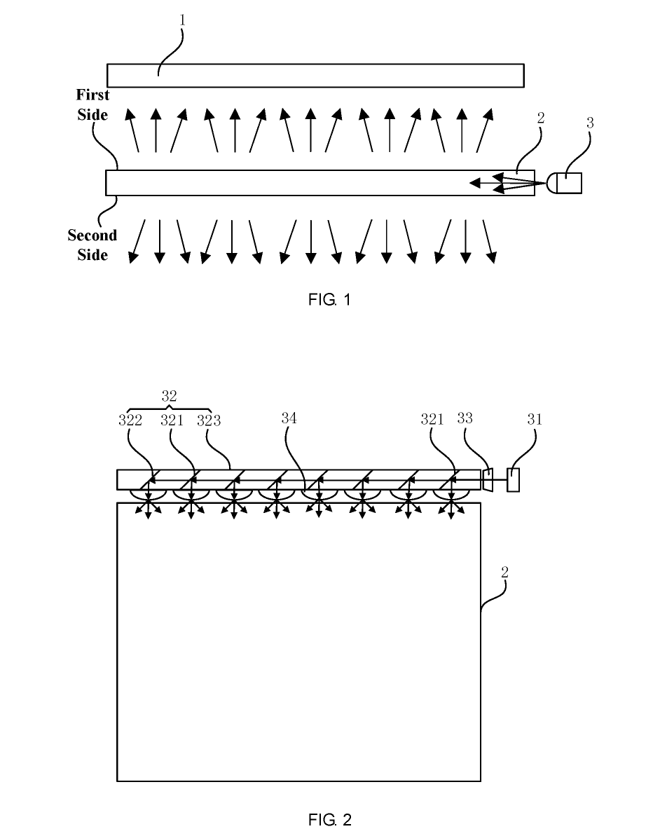

FIG. 1 is a schematic diagram showing a structure of a wireless charging device according to an embodiment of the present disclosure. As shown in FIG. 1, the wireless charging device includes a photovoltaic cell panel 1, a light guide plate 2 and a light source 3.

The light source 3 is configured to provide the light guide plate 2 with incident light. The light guide plate 2 is configured to emit first outgoing light from a first side (e.g., the upper side as shown in FIG. 1) of the light guide plate 2 to the photovoltaic cell panel 1, and emit second outgoing light from a second side (e.g., the lower side as shown in FIG. 1) of the light guide plate 2 opposite to the first side. For example, the light guide plate 2 may emit the second outgoing light from the second side to a display panel. In the embodiment of FIG. 1, an amount of the first outgoing light and an amount of the second outgoing light may be substantially equal to each other. The photovoltaic cell panel 1 is configured to generate electrical power according to the first outgoing light. For example, the photovoltaic cell panel 1 may include any one of known photovoltaic cells. It should be noted that, a display panel is not a component of the wireless charging device, and thus is not illustrated in FIG. 1.

In an embodiment, the second outgoing light emitted from the second side of the light guide plate 2 to a display panel may function as backlight for the display panel, enabling the display panel to perform normal display. The light guide plate 2 further emits the first outgoing light from the first side to the photovoltaic cell panel 1, in this sense, the light guide plate 2 also functions as a diffuser plate for the photovoltaic cell panel 1, such that the first outgoing light is uniformly irradiated on a surface of the photovoltaic cell panel 1 proximal to the light guide plate 2. In the present embodiment, the light guide plate 2 also functions as the diffuser plate, thereby reducing the cost of the wireless charging device.

In the present embodiment, the photovoltaic cell panel 1 may convert the first outgoing light into electric power. In an embodiment, the photovoltaic cell panel 1 supplies the generated electric power to a driver chip of a display device, such that the driver chip drives the display device to operate normally.

In an embodiment, the light source 3 may be located at a side of the light guide plate 2 other than the first and second sides, as shown in FIG. 1. There may be no light emitted from a side of the light guide plate 2 opposite to the light source 3. For example, a reflector may be provided at the side of the light guide plate 2 opposite to the light source 3, so as to prevent light emitting therefrom.

FIG. 2 is a schematic diagram showing a structure of the light source 3 of the wireless charging device shown in FIG. 1. As shown in FIGS. 1 and 2, the light source 3 includes a light source generator 31 and a transflective layer 32. The transflective layer 32 includes a plurality of transflective films 321 arranged sequentially and with an interval therebetween. In an embodiment, the plurality of transflective films 321 may be arranged parallel to each other and aligned with each other in a direction of an axis of a light beam emitted from the light source generator 31. In an embodiment, the plurality of transflective films 321 may be inclined relative to the axis of the light beam emitted from the light source generator 31, as shown in FIG. 2. In an embodiment, an inclination angle of each of the plurality of transflective films 321 relative to the axis of the light beam emitted from the light source generator 31 may be 45 degrees. The light source generator 31 is configured to emit light (or the light beam) and cause the emitted light to be irradiated on the transflective layer 32. The transflective layer 32 is configured to transform the light emitted from the light source generator 31 into incident light of the light guide plate 2, and cause the incident light of the light guide plate 2 to be irradiated on the light guide plate 2. Specifically, the light emitted from the light source generator 31 passes through each of the plurality of transflective films 321 sequentially. In the embodiment of FIG. 2, upon being incident on each of the plurality of transflective films 321, the incident light emitted from the light source generator 31 has a part which is reflected from the transflective film 321 to the light guide plate 2, and the other part which passes through the transflective films 321 to be incident on a next transflective film 321. In this way, the light emitted from the light source generator 31 is incident into the light guide plate 2 uniformly. The light guide plate 2 is configured to emit the first outgoing light from the first side (e.g., the left side in FIG. 2) thereof to the photovoltaic cell panel 1, and emit the second outgoing light from the second side (e.g., the right side in FIG. 2) thereof opposite to the first side.

In an embodiment, the transflective layer 32 further includes one reflector 322 provided at a side of all of the transflective films 321 distal to the light source generator 31. In other words, the plurality of transflective films 321 and the one reflector 322 are arranged sequentially, and the reflector 322 is distal to the light source generator 31. The reflector 322 is configured to reflect light transmitted from the transflective films 321 to the light guide plate 2, so that the light emitted from the light source generator 31 is irradiated on the light guide plate 2 as much as possible. In an embodiment, the plurality of transflective films 321 and the reflector 322 may be inclined relative to the axis of the light beam emitted from the light source generator 31, as shown in FIG. 2. In an embodiment, both an inclination angle of each of the plurality of transflective films 321 and an inclination angle of the reflector 322, relative to the axis of the light beam emitted from the light source generator 31, may be 45 degrees.

In the present embodiment, both the transflective films 321 and the reflector 322 are arranged to be inclined relative to the axis of the light beam emitted from the light source generator 31 at a same angle, such that a larger part of the light emitted from the light source generator 31 is irradiated on the light guide plate 2. Thus, a utilization rate of the light emitted from the light source generator 31 is increased.

In an embodiment, the light source 3 further includes a coupler 33 provided between the light source generator 31 and the transflective layer 32. The light emitted from the light source generator 31 is irradiated on the transflective films 321 in the transflective layer 32 after passing through the coupler 33. In other words, the coupler 33 is configured to couple the light emitted from the light source generator 31 to the transflective layer 32.

In an embodiment, the light source 3 further includes a plurality of lenses 34 in one-to-one correspondence with the plurality of transflective films 321 and provided between the transflective layer 32 and the light guide plate 2. For example, each of the plurality of lenses 34 is provided between a corresponding transflective film 321 and the light guide plate 2. In an embodiment, the light source 3 further includes a lens 34 corresponding to the reflector 322, and the lens 34 corresponding to the reflector 322 is provided between the reflector 322 and the light guide plate 2. Each of the above lenses 34 may include one of a convex lens and a concave lens. Each of the transflective films 321 may reflect the light to a corresponding lens 34, and the reflector 322 may reflect the light to its corresponding lens 34. Each of the lenses 34 may diffuse the received light to form the incident light of the light guide plate 2, and cause the diffused light to be irradiated on the light guide plate 2.

In an embodiment, the transflective layer 32 further includes a support 323 on which the sequentially arranged transflective films 321 are provided. Further, the reflector 322 is provided on the support 323. For example, the support 323 may be transparent to the light emitted from the light source generator 31.

In an alternative embodiment, the transflective layer further includes an optical waveguide in which the sequentially arranged transflective films 321 are provided. Further, the reflector 322 is provided in the optical waveguide. The optical waveguide may be a strip-shaped optical waveguide. By employing the optical waveguide, the utilization rate of the light emitted from the light source generator 31 may be further increased. In this case, the reference numeral “323” in FIG. 2 may also denote the optical waveguide.

In an embodiment, the light source generator 31 may be a laser generator, and the light emitted from the light source generator 31 may be laser. For example, the laser emitted from the light source generator 31 may be visible light.

In the wireless charging device according to the present embodiment, the light source provides the light guide plate with incident light. The light guide plate emits the first outgoing light from the first side of the light guide plate to the photovoltaic cell panel, and emits the second outgoing light from the second side of the light guide plate, for example, to a display panel. The photovoltaic cell panel generates electrical power according to the first outgoing light. In the present embodiment, wireless charging is realized by the light source, the light guide plate and the photovoltaic cell panel, and a power line is not required to supply power, thereby increasing the aesthetic property of a display device including the wireless charging device. Further, in the present embodiment, backlight may be provided to a display panel in addition to the realization of wireless charging, and thus it is not necessary to provide a display panel with a separate backlight.

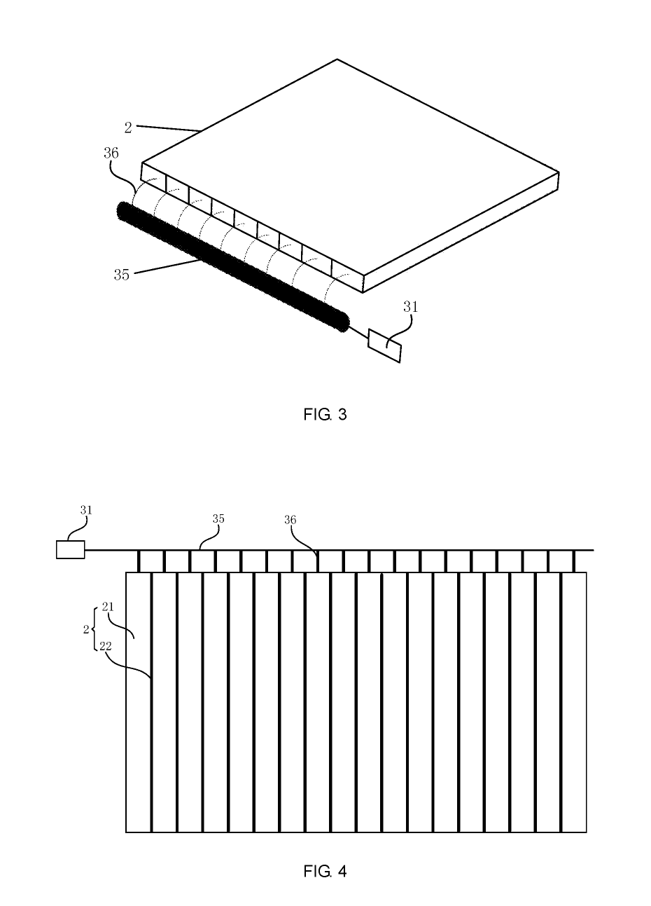

FIG. 3 is a schematic perspective diagram showing a light source and a light guide plate of a wireless charging device according to another embodiment of the present disclosure, and FIG. 4 is a schematic plan view showing the light source and the light guide plate shown in FIG. 3. As shown in FIGS. 3 and 4, the wireless charging device according to the present embodiment differs from that according to the embodiment of FIG. 1 in that, the light guide plate 2 includes a plurality of light guide strips 21 and a plurality of spacers 22, and the plurality of light guide strips 21 and the plurality of spacers 22 are arranged alternately. The light source 3 includes the light source generator 31, a main fiber 35 and a plurality of sub-fibers 36 in one-to-one correspondence with the plurality of light guide strips 21, and each of the plurality of light guide strips 21 is connected to the main fiber 35 through the corresponding sub-fiber 36. The light source generator 31 is configured to emit light and cause the emitted light to be irradiated on the main fiber 35. The main fiber 35 is configured to introduce the light emitted from the light source generator 31 into the plurality of sub-fibers 36 to form incident light of the light guide plate 2. Each of the sub-fibers 36 is configured to guide the light emitted from the light source generator 31 to the corresponding light guide strip 21. The light guide plate 2 is configured to emit the first outgoing light from the first side (e.g., the left side in FIG. 4) of the light guide plate 2 to the photovoltaic cell panel 1, and emit the second outgoing light from the second side (e.g., the right side in FIG. 4) of the light guide plate 2.

In the present embodiment, the light guide strips 21 are spaced apart from each other by the respective spacers 22. Each of the light guide strips 21 plays the role of light guide, and each of the spacers 22 plays the role of separating the light guide strips 21 adjacent thereto from each other, and makes the light distributed uniformly. For example, each of the spacers 22 may be a diffuser, which enables the light incident into the light guide plate 2 to emit from both the first side and the second side of the light guide plate 2 uniformly.

In the present embodiment, the light source generator 31 may be a laser generator, and the light emitted from the light source generator 31 may be laser, for example, may be visible light.

In the wireless charging device according to the present embodiment, the light source provides the light guide plate with incident light. The light guide plate emits the first outgoing light from the first side of the light guide plate to the photovoltaic cell panel, and emits the second outgoing light from the second side of the light guide plate, for example, to a display panel, the first side being opposite to the second side. The photovoltaic cell panel generates electrical power according to the first outgoing light. In the present embodiment, wireless charging is realized by the light source, the light guide plate and the photovoltaic cell panel, and a power line is not required to supply power, thereby increasing the aesthetic property of a display device including the wireless charging device. Further, in the present embodiment, backlight may be provided to a display panel in addition to the realization of wireless charging, and thus it is not necessary to provide a display panel with a separate backlight.

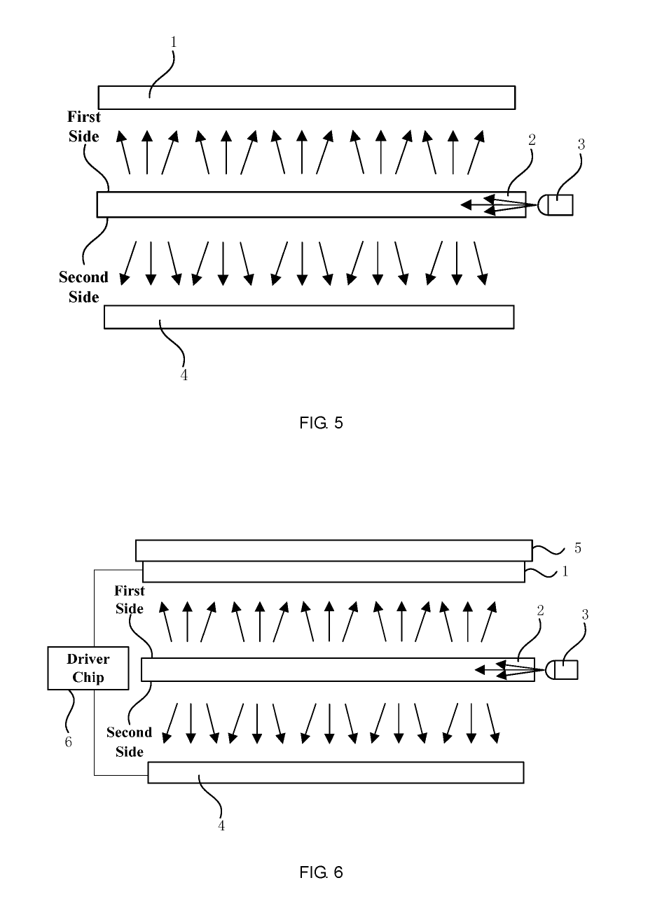

FIG. 5 is a schematic diagram showing a structure of a display device according to another embodiment of the present disclosure. As shown in FIG. 5, the display device includes the wireless charging device according to any one of the embodiments of the present disclosure and a display panel 4. In the display device, the photovoltaic cell panel 1 is located at the first side of the light guide plate 2, and the display panel 4 is located at the second side of the light guide plate 2, the first side being opposite to the second side. The display panel 4 in the present embodiment may be a liquid crystal display panel.

The wireless charging device in the present embodiment may be the wireless charging device according to the embodiment of FIG. 1 or the wireless charging device according to the embodiment of FIGS. 3 and 4. Detailed description of the wireless charging device may be referred to the foregoing description of the embodiment of FIG. 1 and the embodiment of FIGS. 3 and 4, and thus is omitted here.

As shown in FIG. 6, in an embodiment, the display device may further include a back plate 5 and a driver chip 6. In this case, the photovoltaic cell panel 1 may be provided on the back plate 5, and the driver chip 6 may be connected to both the photovoltaic cell panel 1 and the display panel 4. The photovoltaic cell panel 1 may supply the generated electric power to the driver chip 6, such that the driver chip 6 drives the display panel 4 to display. In the present embodiment, the display panel may be a liquid crystal display panel, and the driver chip 6 may be any known driver chip for driving the liquid crystal display panel.

Alternatively, the display device according to any one of the embodiments of FIGS. 5 and 6 may also be an electronic picture frame or the like.

In the display device according to any one of the above embodiments, the light source provides the light guide plate with incident light. The light guide plate emits the first outgoing light from the first side of the light guide plate to the photovoltaic cell panel, and emits the second outgoing light from the second side of the light guide plate to a display panel, the first side being opposite to the second side. The photovoltaic cell panel generates electrical power according to the first outgoing light. In the present embodiment, wireless charging is realized by the light source, the light guide plate and the photovoltaic cell panel, and a power line is not required to supply power, thereby increasing the aesthetic property of the display device. Further, in the present embodiment, backlight may be provided to the display panel in addition to the realization of wireless charging, and thus it is not necessary to provide the display panel with a separate backlight.

It should be understood that, the above embodiments are only exemplary embodiments for the purpose of explaining the principle of the present disclosure, and the present disclosure is not limited thereto. For one of ordinary skill in the art, various improvements and modifications may be made without departing from the spirit and essence of the present disclosure. These improvements and modifications also fall within the protection scope of the present disclosure.

What is claimed is:

1. A wireless charging device, comprising a photovoltaic cell panel, a light guide plate and a light source, wherein
the light source is configured to provide the light guide plate with incident light;
the light guide plate is configured to emit first outgoing light from a first side of the light guide plate to the photovoltaic cell panel, and emit second outgoing light from a second side of the light guide plate opposite to the first side; and
the photovoltaic cell panel is configured to generate electrical power according to the first outgoing light.

2. The wireless charging device according to claim 1, wherein the light source comprises a light source generator and a transflective layer, the transflective layer comprises a plurality of transflective films arranged sequentially and with an interval therebetween;
the light source generator is configured to provide a light beam emitted therefrom to the transflective layer; and
the transflective layer is configured to transform the light beam emitted from the light source generator into incident light for the light guide plate, and provide the incident light to the light guide plate.

3. The wireless charging device according to claim 2, wherein the transflective layer further comprises one reflector provided at a side of all of the plurality of transflective films distal to the light source generator.

4. The wireless charging device according to claim 2, wherein the light source further comprises a coupler provided between the light source generator and the transflective layer, and configured to couple the light beam emitted from the light source generator to the transflective layer.

5. The wireless charging device according to claim 2, wherein the light source further comprises a plurality of lenses in one-to-one correspondence with the plurality of transflective films, and the plurality of lenses are provided between the transflective layer and the light guide plate.

6. The wireless charging device according to claim 5, wherein each of the plurality of lenses is provided between a corresponding one of the transflective films and the light guide plate.

7. The wireless charging device according to claim 3, wherein the light source further comprises a lens corresponding to the reflector and provided between the reflector and the light guide plate.

8. The wireless charging device according to claim 5, wherein each of the plurality of lenses comprises one of a convex lens and a concave lens.

9. The wireless charging device according to claim 7, wherein the lens comprises one of a convex lens and a concave lens.

10. The wireless charging device according to claim 3, wherein the transflective layer further comprises a support on which the plurality of transflective films and the reflector are provided.

11. The wireless charging device according to claim 3, wherein the transflective layer further comprises an optical waveguide in which the plurality of transflective films and the reflector are provided.

12. The wireless charging device according to claim 3, wherein the plurality of transflective films and the reflector are arranged to be inclined relative to an axis of the light beam emitted from the light source generator.

13. The wireless charging device according to claim 12, wherein the plurality of transflective films and the reflector have a same inclination angle relative to the axis of the light beam emitted from the light source generator.

14. The wireless charging device according to claim 13, wherein the inclination angle of the plurality of transflective films and the reflector relative to the axis of the light beam emitted from the light source generator is 45 degrees.

15. The wireless charging device according to claim 1, wherein the light guide plate comprises a plurality of light guide strips and a plurality of spacers, and the plurality of light guide strips and the plurality of spacers are arranged alternately.

16. The wireless charging device according to claim 15, wherein the light source comprises a light source generator, a main fiber and a plurality of sub-fibers in one-to-one correspondence with the plurality of light guide strips, and each of the plurality of light guide strips is connected to the main fiber through a corresponding sub-fiber.

17. The wireless charging device according to claim 16, wherein the light source generator is configured to emit light and provide the light to the main fiber;
the main fiber is configured to introduce the light emitted from the light source generator into the plurality of sub-fibers to form incident light of the light guide plate; and
each of the plurality of sub-fibers is configured to provide the incident light to a corresponding light guide strip.

18. The wireless charging device according to claim 2, wherein the light source generator is a laser generator, and the light emitted from the light source generator is laser.

19. The wireless charging device according to claim 16, wherein the light source generator is a laser generator, and the light emitted from the light source generator is laser.

20. A display device, comprising the wireless charging device according to claim 1 and a display panel, wherein
the photovoltaic cell panel is located at the first side of the light guide plate, and the display panel is located at the second side of the light guide plate.
